(19) United States
(12) Patent Application Publication
(10) Pub. No.: US 2006/0202974 A1
(43) Pub. Date: Sep. 14, 2006

(54) Surface

(76) Inventor: Jeffrey Thielman, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/077,916

(22) Filed: Mar. 10, 2005

(51) Int. Cl. G09G 5/00

(52) U.S. Cl. 345/175

(57) ABSTRACT

Embodiments including a surface are disclosed.

### BACKGROUND

Touch screen technologies may be used in a wide variety of settings and for a wide variety of purposes, including, but not limited to, point-of-sale terminals, electronic games, automatic teller machines, computer interfaces, interactive signage, etc. These technologies allow a single point of interaction, typically via a fingertip or a stylus. However, these technologies are limited to detecting a single object on the touch screen, whether the object is a fingertip, a stylus, or other type of object.

### BRIEF DESCRIPTION OF THE DRAWINGS

The claimed subject matter will be understood more fully from the detailed description given below and from the accompanying drawings of embodiments which, however, should not be taken to limit the claimed subject matter to the specific embodiments described, but are for explanation and understanding of the disclosure.

FIG. 1 is a block diagram of one embodiment of an example touch screen system with multiple optical sensors.

FIG. 2 is a block diagram of one embodiment of an example touch screen system with multiple optical sensors.

FIG. 3 is a block diagram of one embodiment of an example touch screen system showing two objects on the touch screen surface.

FIG. 4 is a graph depicting illumination intensity for one embodiment as sensed by a sensor comprising a linear array of pixels.

FIG. 5 is a block diagram of one embodiment of an example touch screen system illustrating multiple sensors gathering location information for multiple objects on a touch screen surface.

FIG. 6 is a block diagram of one embodiment of an example touch screen system illustrating the calculation of possible intersection points.

FIG. 7 is a flow diagram of one embodiment of an example method for detecting multiple touch screen objects.

FIG. 8 is a block diagram of one embodiment of an example touch screen system illustrating multiple sensors gathering location information for multiple objects on a touch screen surface where one object is hidden from one of the sensors.

FIG. 9 is a block diagram of one embodiment of an example touch screen system with multiple optical sensors.

FIG. 10 is a block diagram of one embodiment of an example system including a display device that delivers position data for multiple touch screen objects to an electronic device.

FIG. 11 is a block diagram of one embodiment of an example system including a display device that delivers touch screen sensor data for multiple objects to an electronic device that includes a processor.

### DETAILED DESCRIPTION

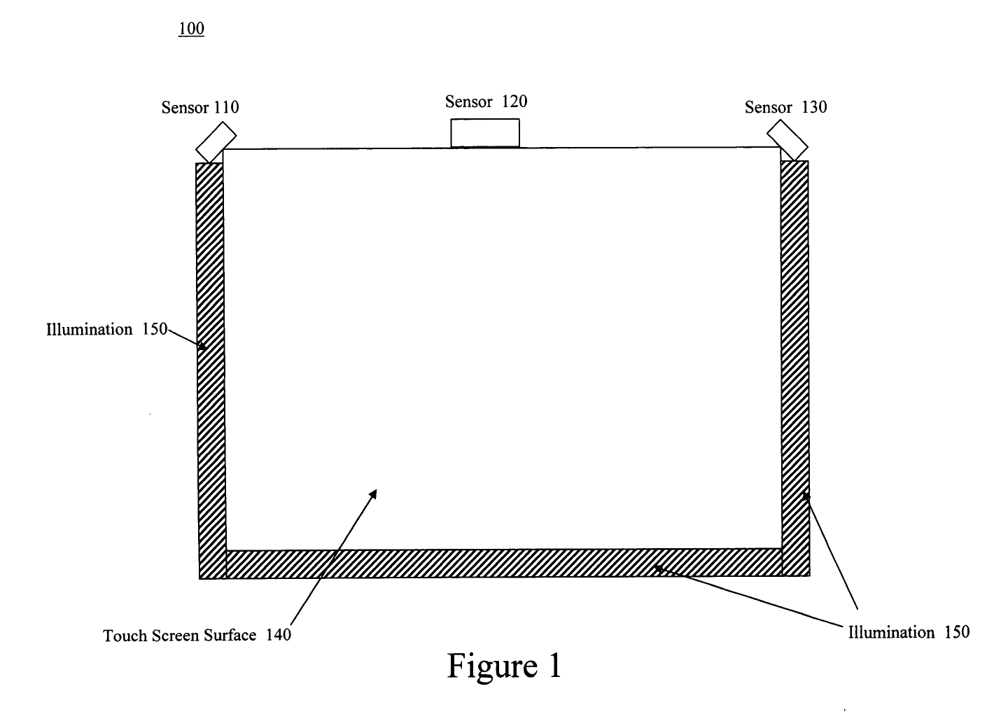

FIG. 1 is a block diagram of one embodiment of an example touch screen system 100 with multiple optical sensors 110, 120, and 130. For this example embodiment, sensors 110 and 130 are located at the upper corners of a touch screen surface 140. Illumination devices 150 are located around the periphery of touch screen surface 140. For this example embodiment, illumination devices 150 are located on three edges of touch screen 140.

For this example embodiment, touch screen surface 140 may include display technologies, perhaps a liquid crystal display (LCD), to provide display of graphics or video images. Other embodiments are possible where touch screen surface 140 does not provide display of graphics or video images. Also for this example embodiment, illumination devices 150 may include infra-red light sources. Other embodiments are possible using other illumination sources, including but not limited to, visible light, ultra-violet, radio frequency, etc. Sensors 110, 120, and 130 for this and other embodiments may comprise line-scan sensors (linear array cameras). Other embodiments may use other types of sensors.

The use of multiple sensors in example system 100 provides the ability to determine the locations of multiple objects interacting with touch screen surface 140. For this and other embodiments, interacting with a surface includes touching or approximately touching the surface. In the example system 100, the three sensors 110, 120, and 130 allow for the detection of two objects. Other embodiments may include a greater number of sensors, thereby allowing for the detection of a greater number of objects. These objects may be detected substantially simultaneously or one after the other.

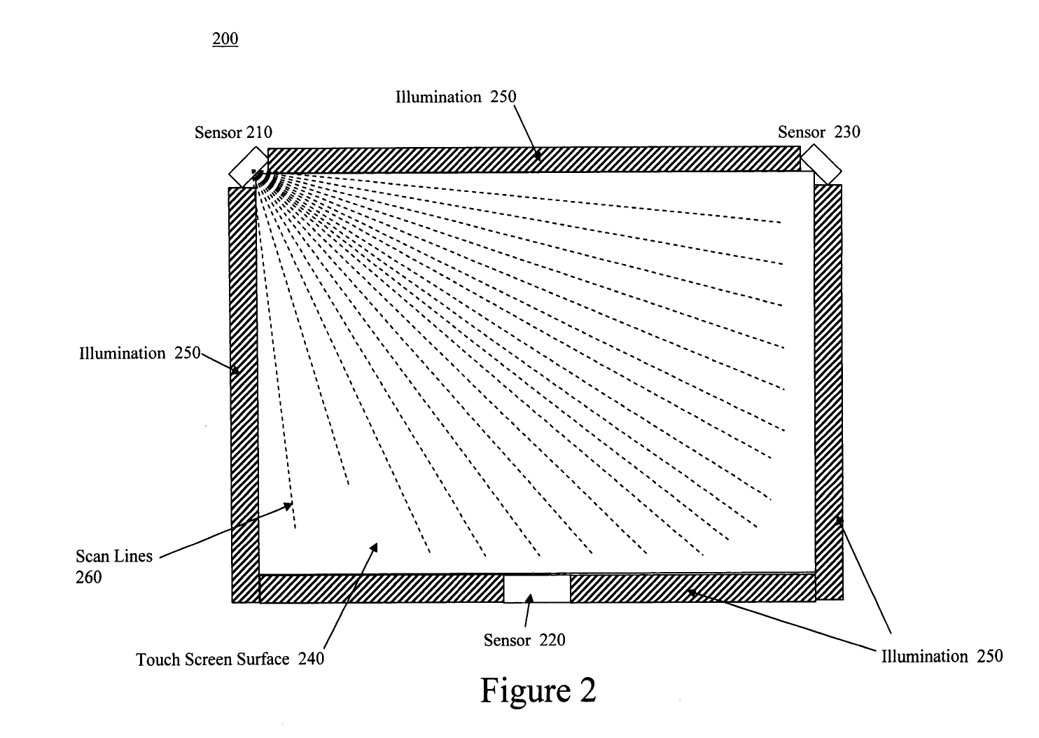

FIG. 2 is a block diagram of one embodiment of an example touch screen system 200 with multiple optical sensors 210, 220, and 230. Example system 200 may share many properties with example system 100, discussed above. System 200, however, locates one of its sensors (sensor 220) along the bottom edge of touch screen surface 240. Further, illumination devices 250 are located in this example embodiment along at least a portion of each of the edges of touch screen 240.

FIG. 2 also depicts scan lines 260. Scan lines 260 are associated with sensor 210. For this example embodiment, sensors 210, 220, and 230 may comprise linear array cameras. Sensors 210, 220, and 230 receive illumination from illumination sources 250 that are arrayed around much of the periphery of touch screen surface 240. Scan lines 260 as depicted in FIG. 2 are meant to illustrate an approximate coverage area for sensor 210 and to show that sensor 210 receives illumination from illumination sources 250. Scan lines 260 do not appear on the touch screen surface, and are shown merely for illustrative purposes. For this example embodiment, sensors 210, 220, and 230 may comprise one thousand pixels arrayed in a linear fashion. Sensors 210 and 230 may be implemented to sense illumination intensity over an area with a range of approximately 90°. Sensor 220 may be implemented to sense illumination intensity over an area with a range of approximately 180°.

Although the example systems discussed herein utilize rectangular touch screen surfaces, other embodiments are possible using other shapes. Further, a wide range of possible sensor and illumination device arrangements and configurations are possible. For example, one embodiment may place a sensor at each corner of a rectangular touch screen surface.

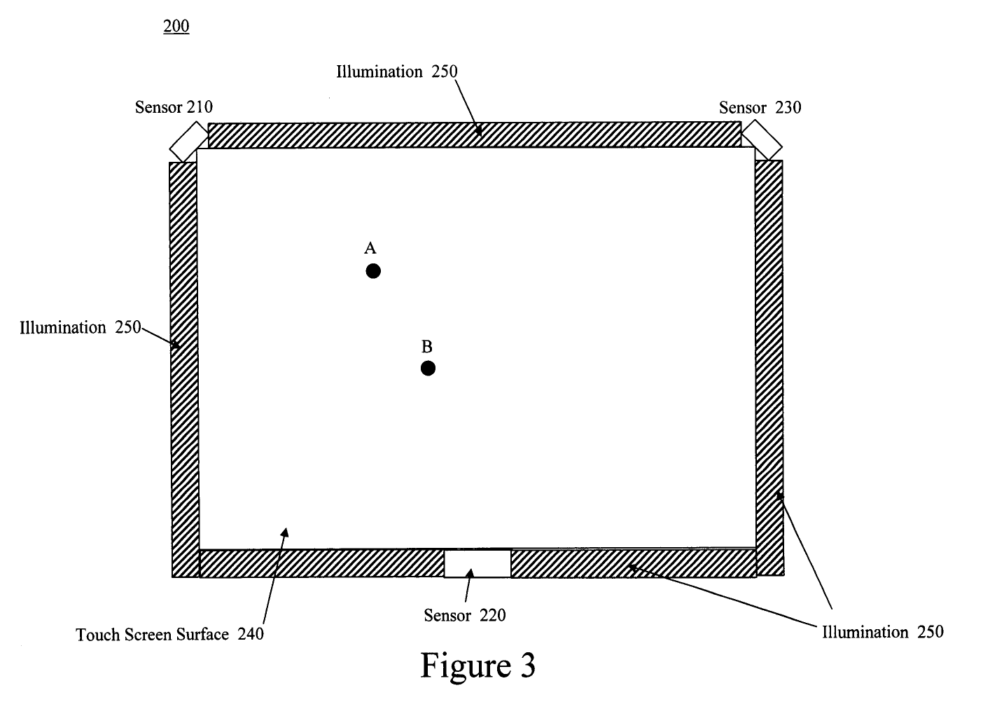

FIG. 3 is a block diagram of example touch screen system 200 showing an object A and an object B interacting with the touch screen surface. Each of the objects may be a fingertip, a stylus, or other type of device for interacting with a touch screen. Each of the objects may be a different type of object (one may be a stylus and the other may be a fingertip, for example). The location of objects A and B shown in FIG. 3 are merely for illustrative purposes. Objects may be detected at a wide range of locations on or above the touch screen surface.

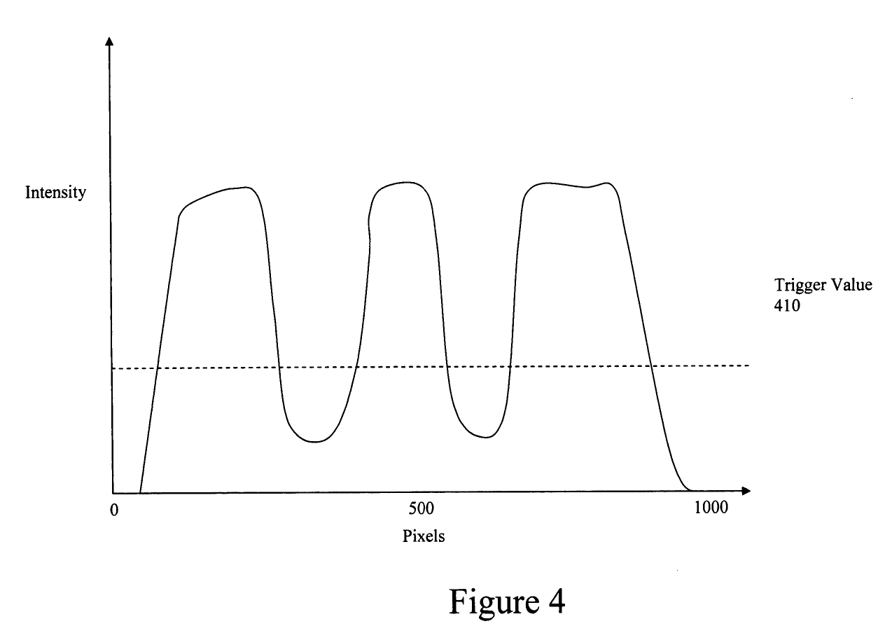

FIG. 4 is a graph depicting illumination intensity as sensed by sensor 210 comprising a linear array of pixels. For this example embodiment, sensor 210 comprises one thousand pixels configured in a linear array. FIG. 4 shows a drop in illumination intensity at two locations on the graph. The drops in intensity are due to objects A and B interacting with touch screen surface 240. For this example, the drops in intensity are centered at approximately pixels 350 and 550. Each of the pixels may be associated with an angle value. For example, pixel 350 may correspond to an angle of 43° and pixel 550 may correspond to an angle of 50°. The angle values associated with the various pixels may be predetermined and/or programmable. For this example embodiment, the angle values associated with the pixels of sensor 210 represent angles between the top edge of touch screen surface 240 and scan lines associated with the various pixels.

For this example embodiment, hardware circuitry, software, or firmware, or a combination of software, firmware, and hardware may determine on which pixel the drops in illumination intensity associated with objects interacting with a touch screen surface are centered. This determination is made in response to a drop in intensity where the intensity falls below a predetermined and/or programmable trigger value 410.

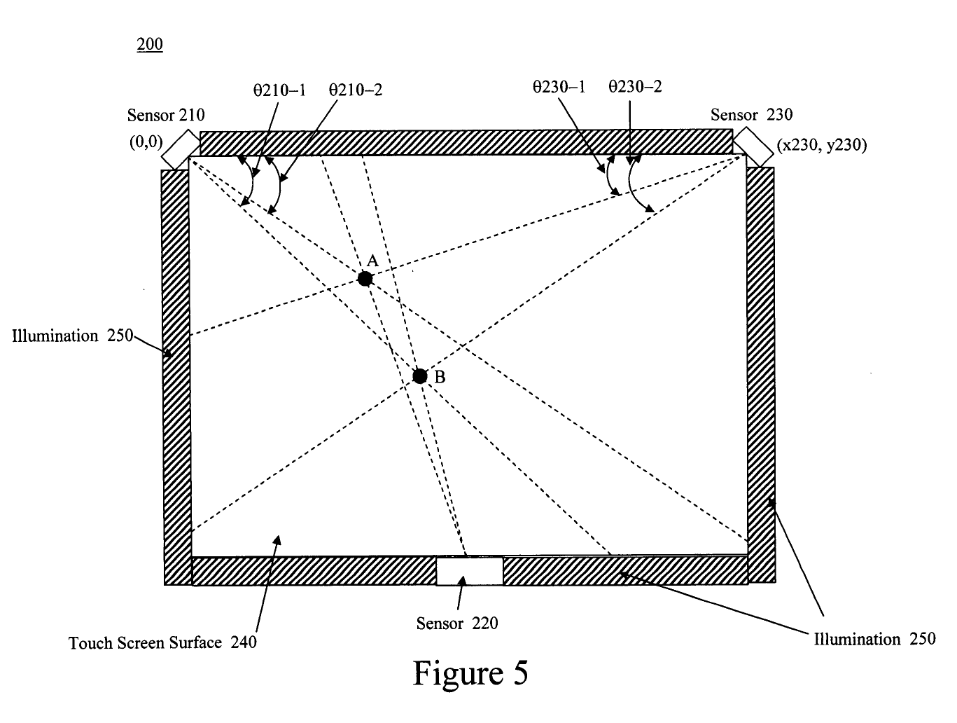

FIG. 5 is a block diagram of example touch screen system 200 illustrating sensors 210, 220, and 230 sensing location information for objects A and B interacting with touch screen surface 240. Sensors 210, 220, and 230 may detect varying levels of infra-red light due to the presence of objects A and B. Sensors 210, 220, and 230 may for this example embodiment detect angles at which the infra-red light variation occurs. The angle information may be delivered to a processing or calculation device (not shown). In other embodiments, sensors may deliver pixel data to a processor or calculation unit to determine angle information.

With the location information, which for this example embodiment is angle information related to drops in illumination intensity sensed by sensors 210, 220, and 230, a processing or calculation device or unit can determine possible intersection points. Angle information from multiple sensors may be used to determine which of the possible intersection points are valid objects.

For this example, a two-dimensional coordinate system may be centered at the location of sensor 210. The location of sensor 230 may be designated by coordinates (x230, y230). Two angles associated with sensor 210 are labeled θ210-1 and θ210-2. Two angles associated with sensor 230 are labeled θ230-1 and θ230-2. These angle values correspond to angles made between scan lines intersecting either object A or object B and the top edge of touch screen surface 240.

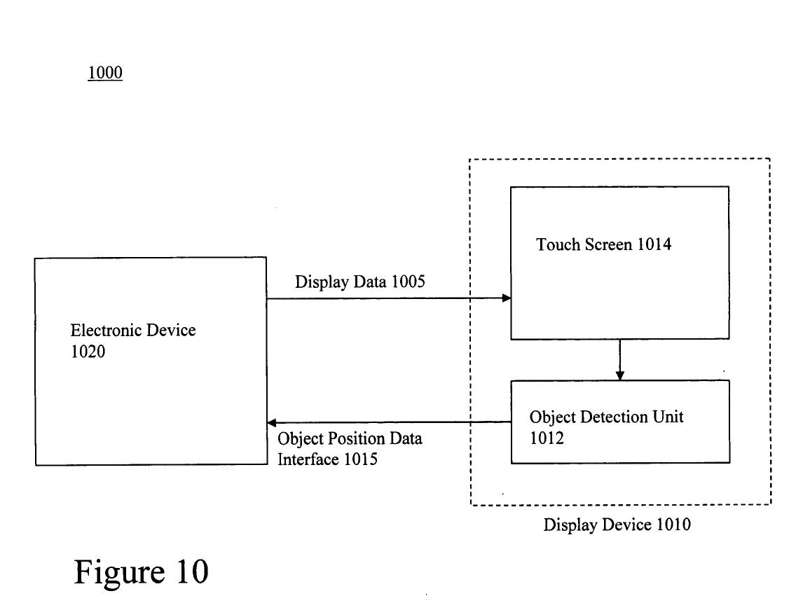

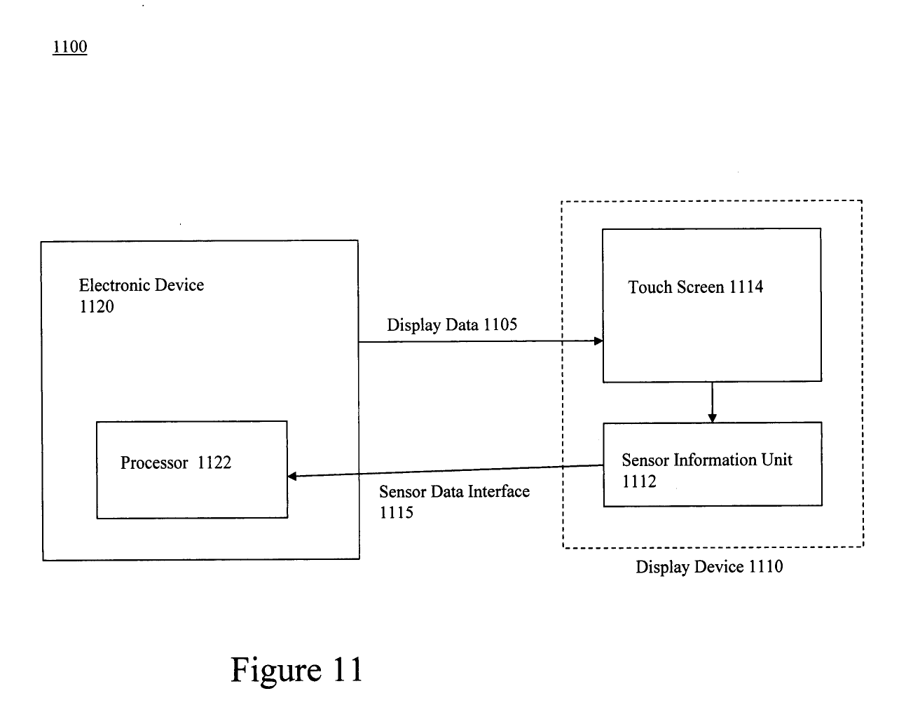

The angle information from sensors 210, 220, and 230 may be used to determine a list of possible intersection points. Because each sensor for this example detects a drop in illumination intensity at two locations, each sensor may provide information for two angles. The information from the three sensors may provide a total of eight possible intersection points for this example. For example, the angle information for θ210-1 and θ230-1 can be used to find one intersection point. In one embodiment, the intersection point may be determined according to the following equations:
x=[x230*tan(θ230-1)−y230]/[tan(θ210-1)+tan(θ230-1)]
y=−tan(θ210-1)*x
The remaining intersection points may be determined in a similar fashion. Determination of the intersection points may be accomplished by a software or firmware agent running on a processor or other programmable execution unit, or may be accomplished using dedicated circuitry (see FIGS. 10 and 11 and associated discussion).

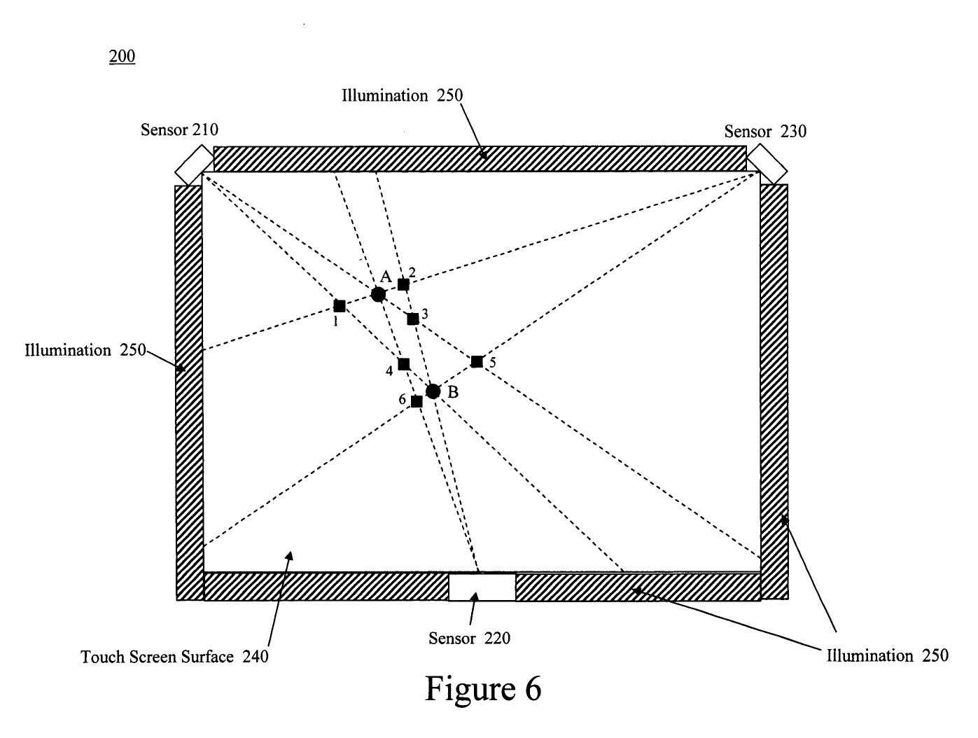

In FIG. 6, objects A and B are shown along with intersection points 1 through 6. The intersection points represent locations at which rays corresponding to detected angles intersect. The intersection points may be determined using the methods described above in connection with FIG. 5. The rays and intersection points do not appear on the touch screen surface, and are shown merely for illustrative purposes.

Once the possible intersection points are determined, a series of comparisons may be made to determine which of the intersection points represent valid objects. Table 1, below, shows how these comparisons may be accomplished in this example embodiment.

TABLE 1
Intersection Points Comparisons for FIG. 6

| | Sensors | Sensors | Sensors | Valid |
|---|---|---|---|---|
| Points | 210, 220 | 210, 230 | 220, 230 | Object? |
| 1 | False | True | False | No |
| A | True | True | True | Yes |
| 2 | False | False | True | No |
| 3 | True | False | False | No |
| 4 | True | False | False | No |
| 5 | False | True | False | No |
| 6 | False | False | True | No |
| B | True | True | True | Yes |

Referring to Table 1, and looking at FIG. 6, it can be seen that point 1 sits along one of the ray paths corresponding to angle information gathered by sensor 210, but point 1 does not sit along one of the ray paths corresponding to angle information gathered by sensor 220. In other words, point 1 is not one of the intersection points previously determined using the angle information from sensors 210 and 220. Thus, Table 1 indicates a False value for this comparison. The next comparisons are made for rays corresponding to angle information gathered from sensors 210 and 230. As can be seen in FIG. 6, rays from sensors 210 and 230 intersect at point 1. In other words, point 1 is one of the intersection points determined using the angle information from sensors 210 and 230. Therefore, the results of this comparison are marked True in Table 1. Similar comparisons are made for the remaining sensor pair with regard to point 1, and the result is False as indicated in Table 1. Because at least one of the comparisons regarding point 1 resulted in a False value, point 1 is ruled out as a valid object.

Again referring to Table 1 and FIG. 6, it can be seen that point A sits along one of the ray paths corresponding to angle information gathered by sensor 210 and also sits along a ray path corresponding to angle information determined by sensor 220. Thus, Table 1 indicates a “True” value for this comparison. Similarly, it can be seen that point A also sits along one of the ray paths corresponding to angle information gathered by sensor 210 and also sits along a ray path corresponding to angle information determined by sensor 230. Table 1 indicates a “True” value for this comparison. Also, point A also sits along one of the ray paths corresponding to angle information gathered by sensor 220 and also sits along a ray path corresponding to angle information determined by sensor 230. Table 1 indicates a “True” value for this comparison. Because all of the comparisons result in a “True” value, point A is determined to be a valid object.

Comparisons are also made for the remaining points. It can be seen in Table 1 that comparisons for points 2, 3, 4, 5, and 6 result in at least one “False” value, while the comparisons for point B all yield “True” results. Point B is therefore determined to be a valid object.

Another look at Table 1 and FIG. 6 may show why it may be helpful to have at least one more sensor than objects to detect. Assume for this explanation that sensor 230 is not included in system 200. In this case, points A, B, 3, and 4 would appear to be potentially valid objects. A look at Table 1 for the comparisons between sensors 210 and 220 for these points reveals that all of these points test “True” for valid objects. Points 3 and 4 would be erroneously determined to be valid objects if the comparisons between sensors 210 and 220 are included without including any other sensor comparisons. Including the additional sensor (sensor 230 in this case) allows for additional comparisons that are able to discern between valid and invalid objects.

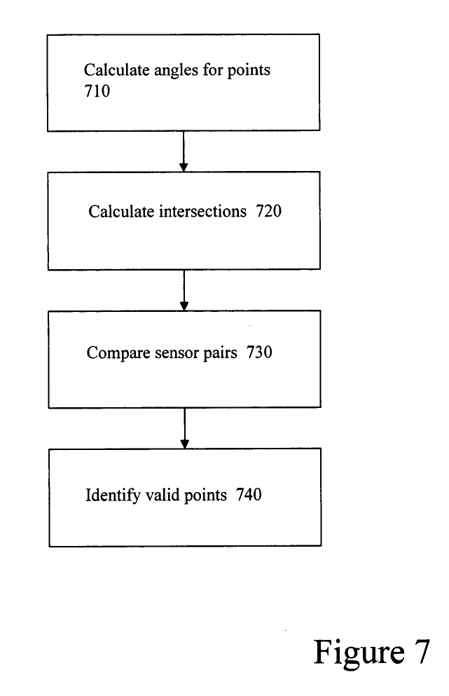

FIG. 7 is a flow diagram of one embodiment of an example method for detecting multiple touch screen objects. At block 710, angles are determined for points detected by sensors. Possible intersections are determined at block 720. Angle and intersection point determinations may occur according to methods described above.

Information from sensor pairs are compared at block 730, and at block 740 valid points are identified. Other embodiments may also include a function after the possible intersections are calculated (block 720) to determine which of the possible intersections may fall outside the boundaries of a touch screen surface area. This function may narrow the list of possible intersection points to possible intersection points that fall geographically within the boundaries of a touch screen surface, and therefore potentially valid object locations. For this example embodiment, possible intersection points that fall outside the boundaries of the touch screen surface area may not be considered to be potentially valid object points.

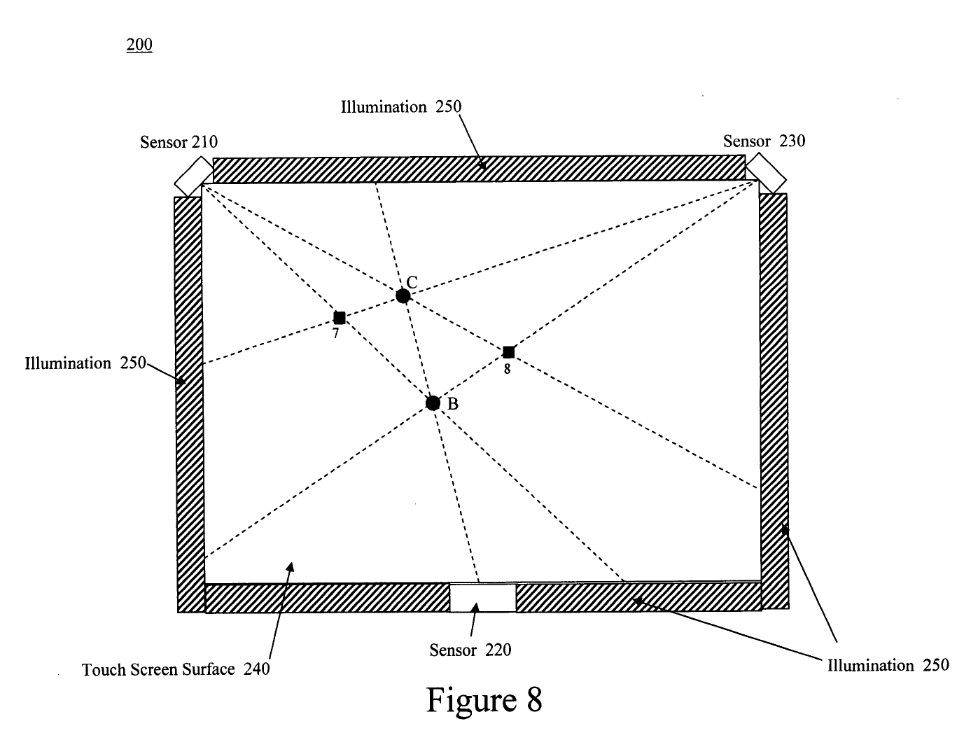

FIG. 8 is a block diagram of one embodiment of an example touch screen system illustrating multiple sensors gathering location information for multiple objects on a touch screen surface where one object is hidden from one of the sensors. The example system 200 for this example may be the same system as discussed above in connection with FIG. 6. For this example, two objects, B and C, are shown. Point B is shown in approximately the same position as shown in FIG. 6, but new object C replaces object A. For this example, object C is hidden from sensor 220 such that sensor 220 detects a variation of light intensity from a single direction. Sensors 210 and 230 detect location information for both points B and C.

TABLE 2
Intersection Points Comparisons for FIG. 8

| | Sensors | Sensors | Sensors | Valid |
|---|---|---|---|---|
| Points | 210, 220 | 210, 230 | 220, 230 | Object? |
| 7 | False | True | False | No |
| C | True | True | True | Yes |
| 8 | False | True | False | No |
| B | True | True | True | Yes |

The comparisons for this example occur in a manner similar to that discussed above in connection with FIG. 6, but because sensor 220 detected only one angle, there are fewer intersections to analyze and fewer comparisons to make. As can be seen in Table 2, all of the comparisons for points B and C yield “True” results, and therefore points B and C are considered to be valid objects. Intersection points 7 and 8 result in comparisons that yield at least one “False” result, and are therefore not considered to be valid objects. These results demonstrate that for this example embodiment an object can be accurately detected even when hidden from one of the sensors.

Although the example discussed in connection with FIG. 8 uses three sensors to detect two objects, other embodiments may include a greater number of sensors in order to detect additional objects.

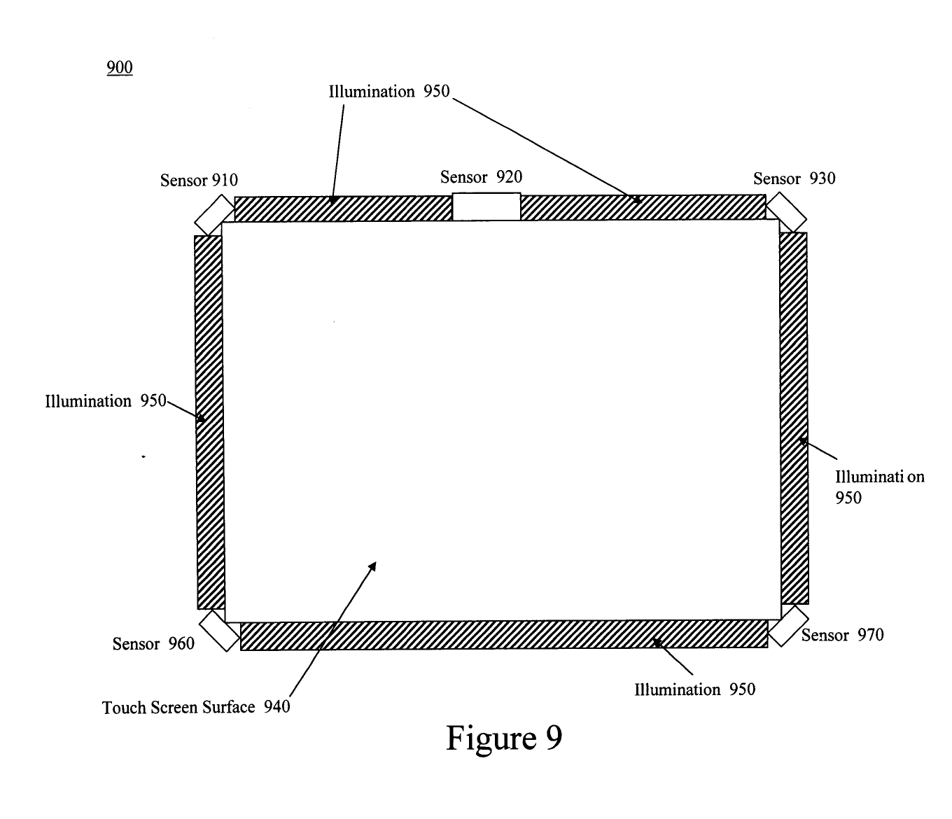

FIG. 9 is a block diagram of one embodiment of an example touch screen system 900 with multiple optical sensors. For this example embodiment, a touch screen surface 940 is surrounded around most of its periphery by illumination devices 950. For this example embodiment, touch screen surface 940 is rectangular in shape, and illumination sources 950 are located along at least a portion of each edge of touch screen surface 940. This example embodiment uses five sensors at various locations around touch screen surface 940. Sensors 910, 930, 960, and 970 are located at the four corners of the rectangular touch screen surface 940. Sensor 920 is located approximately at the midpoint of one of the edges of touch screen surface 940. By using five sensors, example system 900 may detect four objects.

Although the example system 900 discussed herein utilizes a rectangular touch screen surface, other embodiments are possible using other shapes. Further, a wide range of possible sensor and illumination device arrangements and configurations are possible. The illumination devices may include infra-red light sources, and the sensors may include cameras. Other embodiments may use other types of light sources and other types of sensors. Further, although system 900 uses five sensors, other embodiments are possible using a wide range of numbers of sensors.

FIG. 10 is a block diagram of one embodiment of an example system 1000 including a display device 1010 that delivers position data for multiple touch screen objects to an electronic device 1020. Display device 1010 for this example embodiment includes a touch screen 1014 and an object detection unit 1012. Touch screen 1014 may be of a type similar to any of the embodiments mentioned herein. For example, touch screen 1014 may be similar to the example system 200, discussed above.

Touch screen 1014 may include display technologies that allow the display of video and/or graphics images. Electronic device 1020 may deliver display data 1005 to touch screen 1014. Other embodiments are possible where the display device does not display video and/or graphics images and no display data is received, but the display may include a static non-electronic image (paper, cardboard, photograph, poster, etc.).

Electronic device 1020 may include any of a wide range of suitable device types, including, but not limited to, electronic games, computers, cellular phones, interactive signage, etc. Electronic device 1020 and display device 1010 may be integrated into a single device or component, or may be implemented as two or more separate components. Further, touch screen 1014 may be integrated into display device 1010 or may be overlaid on top of display device 1010.

Touch screen 1014 may include a number of sensors that gather location information for a number of potential objects. Object detection unit 1012 may include a processor or other circuitry for performing calculations and may also include sensor information circuitry to gather information from the touch screen sensors. Object detection unit 1012 may perform calculations to determine valid objects. The techniques used by touch screen 1014 and object detection unit 1012 to detect valid objects may be similar to those discussed above in connection with FIGS. 1-9. Once locations for valid objects have been determined, object location information may be transmitted to electronic device 1020 via an object position data interface 1015. Object position data interface 1015 may be a serial interface or a parallel interface. In one embodiment, object position data interface 1015 may adhere to a Universal Serial Bus (USB) standard. The object position data may be formatted to resemble data for multiple mouse pointers. In another embodiment, interface 1015 may adhere to the RS-232 serial protocol. Other embodiments may use wireless technologies for object position data interface 1015.

FIG. 11 is a block diagram of one embodiment of an example system 1100 including a display device 1110 that delivers touch screen sensor data for multiple objects to an electronic device 1120 that includes a processor 1122. Display device 1110 for this example embodiment includes a touch screen 1114 and a sensor information unit 1112. Touch screen 1114 may be of a type similar to any of the embodiments mentioned herein. For example, touch screen 1114 may be similar to the example system 200, discussed above.

Touch screen 1114 may include display technologies that allow the display of video and/or graphics images. Electronic device 1120 may deliver display data 1105 to touch screen 1114.

Electronic device 1120 may include any of a wide range of device types, including, but not limited to, electronic games, computers, cellular phones, interactive signage, etc. Electronic device 1120 and display device 1110 may be integrated into a single device or component, or may be implemented as two or more separate components. Further, touch screen 1114 may be integrated into the display device 1110 or may be overlaid on top of the display device 1110.

Touch screen 1114 may include a number of sensors that gather location information for a number of potential objects. Sensor information unit 1112 delivers information gathered from the sensors to the processor 1122 via a sensor data interface 1015. The processor 1122 may perform calculations to determine valid objects. The techniques used by touch screen 1114 and processor 1122 to detect valid objects may be similar to those discussed above in connection with FIGS. 1-9.

Sensor data interface 1115 may be a serial interface or a parallel interface. In one embodiment, sensor data interface 1115 may adhere to a Universal Serial Bus (USB) standard. Other embodiments may use wireless technologies for interface 1115.

Reference in the specification to “an embodiment,” “one embodiment,” “some embodiments,” or “other embodiments” means that a particular feature, structure, or characteristic described in connection with the embodiments is included in at least some embodiments, but may not be included in all embodiments. The various appearances of “an embodiment,” “one embodiment,” or “some embodiments” may or may not be referring to the same embodiments.

In the foregoing specification the claimed subject matter has been described with reference to specific example embodiments thereof. It will, however, be evident that various modifications and changes may be made thereto without departing from the broader spirit and scope of the subject matter as set forth in the appended claims. The specification and drawings are, accordingly, to be regarded in an illustrative rather than in a restrictive sense.

What is claimed is:

1. An apparatus, comprising:
a surface;
an illumination source situated around at least a portion of the surface; and
at least three cameras located at points on the periphery of the surface.

2. The apparatus of claim 1, wherein the cameras each sense a location of at least one object approximately touching the surface and further wherein the surface comprises a touch screen surface.

3. The apparatus of claim 2, wherein the location of the at least one object is expressed as one or more angles.

4. The apparatus of claim 1, wherein the illumination source includes an infra-red light emitter.

5. The apparatus of claim 1, wherein the cameras comprise linear array cameras.

6. The apparatus of claim 1, wherein at least one of the cameras are located in a corner approximately on the periphery of the surface.

7. A method, comprising:
determining angles for a plurality of objects sensed on a surface;
determining intersection points;
comparing sensed pairs of intersection points; and
identifying those of the intersection points corresponding to the objects.

8. The method of claim 7, further comprising determining which of the intersection points may fall outside the boundaries of a touch screen surface area.

9. The method of claim 7, wherein the determining angles for a plurality of objects sensed on a surface includes illuminating an area and sensing a drop in illumination intensity at a plurality of sensors.

10. The method of claim 9, wherein the sensing a drop in illumination intensity at a plurality of sensors includes sensing a drop in illumination intensity at a subset of a plurality of pixels in one or more line array cameras.

11. The method of claim 9, wherein the determining intersection points includes performing calculations using the angles.

12. The method of claim 11, wherein the comparing sensed pairs of intersection points includes determining if a one of the intersection points is detected by all combinations of pairs of sensors.

13. The method of claim 12, wherein the identifying those of the intersection points corresponding to the objects includes associating locations of the intersection points detected by all combinations of the pairs of sensors with the objects.

14. A method, comprising:
placing an illumination source around at least a portion of a surface;
placing at least three optical sensors located at points on the periphery of the surface; and
sensing a location of at least two objects.

15. The method of claim 9, further comprising expressing the locations of the at least two objects as angles.

16. A system, comprising:
a multiple object pointing device, including
a touch screen surface having at least one edge,
an illumination source situated around at least a portion of the at least one
edge of the touch screen surface,
at least three optical sensors located at points on the periphery of the touch
screen surface, and
an object detection unit; and
an electronic device to receive object position data from the multiple object pointing device.

17. The system of claim 16, wherein the touch screen includes a display, the electronic device to deliver display data to the multiple object pointing device.

18. The system of claim 17, wherein the optical sensors each sense a location of at least one object approximately touching the touch screen.

19. The system of claim 18, wherein the location of the at least one object is expressed as one or more angles.

20. The system of claim 19, wherein the illumination source includes an infra-red light emitter.

21. The system of claim 20, wherein the object detection unit determines valid object locations from the angle information generated by the sensors.

22. The system of claim 21, wherein the object detection unit transmits position data for a plurality of objects to the electronic device.

23. The system of claim 22, wherein the object detection unit transmits object position data to the electronic device via a Universal Serial Bus.

24. An apparatus, comprising:
means for illumination situated around at least a portion of a touch screen surface; and
at least three means for sensing located at points approximately on the periphery of the touch screen surface, wherein the means for sensing senses a drop in illumination intensity at a subset of a plurality of pixels.

25. The apparatus of claim 24, wherein the sensor means each sense a location of at least one object approximately touching the touch screen.

26. The apparatus of claim 25, wherein the location of the at least one object is expressed as one or more angles.

27. The apparatus of claim 26, wherein at least one of the means for sensing is located in a corner approximately on the periphery of the touch screen surface.

28. A machine-readable medium containing instructions that when executed perform a method, comprising:
determining angles for a plurality of objects sensed on a surface;
determining intersection points;
comparing sensed pairs of intersection points; and
identifying those of the intersection points corresponding to the objects.

29. The machine-readable medium of claim 28, further comprising determining which of the intersection points may fall outside the boundaries of a touch screen surface area.

30. The machine-readable medium of claim 28, wherein the determining angles for a plurality of objects sensed on a surface includes illuminating an area and sensing a drop in illumination intensity at a plurality of sensors.

31. An apparatus comprising one or more devices adapted to detect more than one touch screen object, as follows:
determining angles for a plurality of objects sensed on a surface;
determining intersection points;
comparing sensed pairs of intersection points; and
identifying those of the intersection points corresponding to the objects.

32. The apparatus of claim 31, wherein determining angles for a plurality of objects sensed on a surface includes illuminating an area and sensing a drop in illumination intensity at a plurality of sensors.

33. The apparatus of claim 32, wherein sensing a drop in illumination intensity at a plurality of sensors includes sensing a drop in illumination intensity at a subset of a plurality of pixels in one or more line array cameras.

34. The apparatus of claim 33, wherein comparing sensed pairs of intersection points includes determining if a one of the intersection points is detected by all combinations of pairs of sensors.

35. The apparatus of claim 34, wherein identifying those of the intersection points corresponding to the objects includes associating locations of the intersection points detected by all combinations of the pairs of sensors with the objects.
